(19) United States
(12) Patent Application Publication
(10) Pub. No.: US 2007/0089064 A1
(43) Pub. Date: Apr. 19, 2007

(54) Method, system, and program product for accessing undisplayed data

(75) Inventors: Michael D. Facemire, Cary, NC (US); Eric L. Masselle, Raleigh, NC (US); Patrick G. McGowan, Chapel Hill, NC (US); Michael C. Wanderski, Durham, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/250,055

(22) Filed: Oct. 13, 2005

(51) Int. Cl. G06F 9/00

(52) U.S. Cl. 715/764

(57) ABSTRACT

The invention provides a method, system, and program product for accessing and, optionally, displaying data not included in a graphical user interface (GUI) display. In one embodiment, the method includes accessing at least one filter object; and positioning a location indicator adjacent a first portion of the GUI, wherein the at least one filter object is adapted to access data not displayed in the GUI.

### BACKGROUND OF THE INVENTION

1. Technical Field

The invention relates generally to graphical user interfaces (GUIs), and more particularly, to a method, system, and program product for accessing and, optionally, displaying data not displayed in a GUI.

2. Background Art

A computer file often contains a great deal of information about the file itself. Such information may include, for example, dates of creation and modification, the file size and type, and biographical information regarding the file's author. However, a typical graphical user interface (GUI) includes only a small subset of such data in its display. This is done to avoid overcrowding of the display and the performance degradation associated with the transmission and display of large amounts of data. Often, a user may modify or customize the GUI to display data of interest to the user. It is often impractical or impossible, however, for a GUI to display all of the data a user may wish to access. In such a case, a user generally must access a separate detailed or customized display or open the file itself in order to view the desired data. This is inefficient, both in terms of the effort expended by a user and the resources required of the computer system.

To this extent, a need exists for a method, system, and program product for efficiently and easily accessing and displaying data not included in a GUI display.

### SUMMARY OF THE INVENTION

The invention provides a method, system, and program product for accessing and, optionally, displaying data not included in a graphical user interface (GUI) display. In one embodiment, the method includes accessing at least one filter object; and positioning a location indicator adjacent a first portion of the GUI, wherein the at least one filter object is adapted to access data not displayed in the GUI.

A first aspect of the invention provides a method of accessing undisplayed data in a graphical user interface (GUI), the method comprising: accessing at least one filter object; and positioning a location indicator adjacent a first portion of the GUI, wherein the at least one filter object is adapted to access data not displayed in the GUI.

A second aspect of the invention provides a system for accessing undisplayed data in a graphical user interface, the system comprising: a system for accessing at least one filter object; and a system for positioning a location indicator adjacent a first portion of the GUI, wherein the at least one filter object is adapted to access data not displayed in the GUI.

A third aspect of the invention provides a program product stored on a computer-readable medium, which when executed, accesses undisplayed data in a graphical user interface (GUI), the program product comprising: program code for accessing at least one filter object; and program code for positioning a location indicator adjacent a portion of the GUI, wherein the at least one filter object is adapted to access data not displayed in the GUI.

A fourth aspect of the invention provides a method for deploying an application for accessing undisplayed data in a graphical user interface (GUI), comprising: providing a computer infrastructure being operable to access at least one filter object; and position a location indicator adjacent a first portion of the GUI, wherein the at least one filter object is adapted to access data not displayed in the GUI.

A fifth aspect of the invention provides computer software embodied in a propagated signal for accessing undisplayed data in a graphical user interface (GUI), the computer software comprising instructions to cause a computer system to perform the following functions: access at least one filter object; and position a location indicator adjacent a first portion of the GUI, wherein the at least one filter object is adapted to access data not displayed in the GUI.

A sixth aspect of the invention provides a business method for accessing data not displayed in a graphical user interface.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a graphical user interface (GUI) including a menu of filter objects according to an embodiment of the invention.

FIG. 2 shows the GUI of FIG. 1 showing the menu of filter objects in an expanded form.

FIGS. 3A-B show alternative embodiments of the GUI of FIG. 1 including a position indicator and filter display.

FIG. 4 shows the GUI of FIG. 3A including a pair of filter displays.

FIG. 5 shows the GUI of FIG. 3A including an empty filter display.

FIG. 6 shows a block diagram of an illustrative method according to the invention.

FIG. 7 shows an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system, and program product for accessing undisplayed data in a graphical user interface (GUI) display. As used herein, the term “accessing,” when used in relation to undisplayed data, includes obtaining, receiving, reading, viewing, or utilizing data not otherwise included in the GUI.

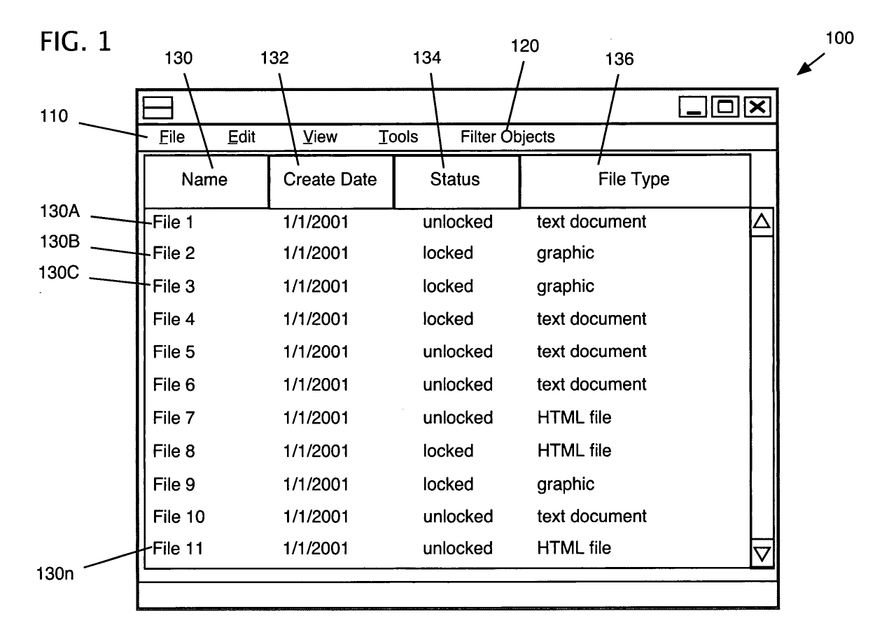

Turning to the drawings, FIG. 1 shows a GUI 100 according to an embodiment of the invention. GUI 100 includes a menu bar 110 having a menu 120 of filter objects. As shown, GUI 100 graphically displays data relating to a plurality of files 130A, 130B, 130C . . . 130n. For each file 130A, 130B, 130C . . . 130n, four data fields 130, 132, 134, 136 are displayed, including “Name” 130, “Create Date” 132, “Status” 134, and “File Type” 136. Data fields 130, 132, 134, 136 are illustrative of data associated with files 130A, 130B, 130C . . . 130n and are not meant to limit the data that may be included, accessed, or displayed.

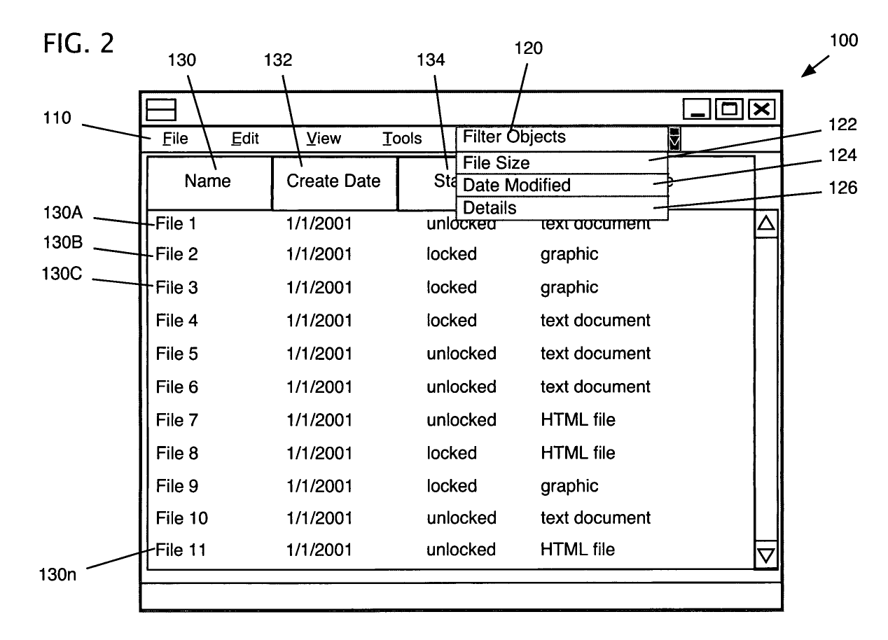

Given the large amount of data often associated with computer files, it is likely that a user may require access to data not displayed in GUI 100. Accordingly, such a user may access the menu 120 of filter objects. Referring now to FIG. 2, an expanded menu 120 is shown including a plurality of filter objects 122, 124, 126. Filter objects 122, 124, 126 may be adapted to access and, optionally, display any data related to or associated with one or more files 130A, 130B, 130C . . . 130n. For example, as shown in FIG. 2, the “File Size” filter object 122 is adapted to access data related to a file's size, the “Date Modified” filter object 124 is adapted to access data related to the date on which the file was most recently modified, and the “Details” filter object 126 may be adapted to access data related to any number of file characteristics, including, for example, the name of the file's author, a program used to create and/or open the file, etc. Filter objects 122, 124, 126 may be pre-defined, user-defined, or modifiable by a user.

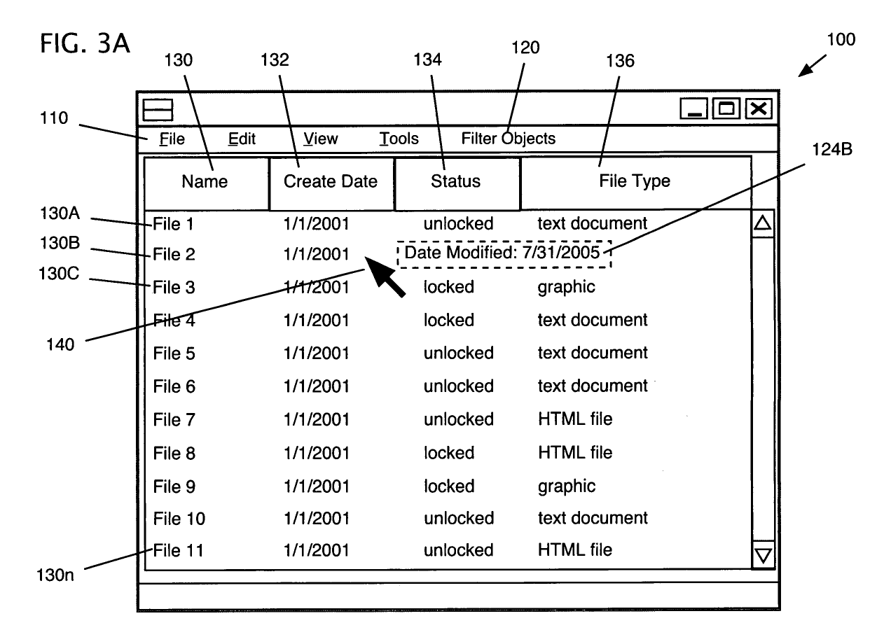

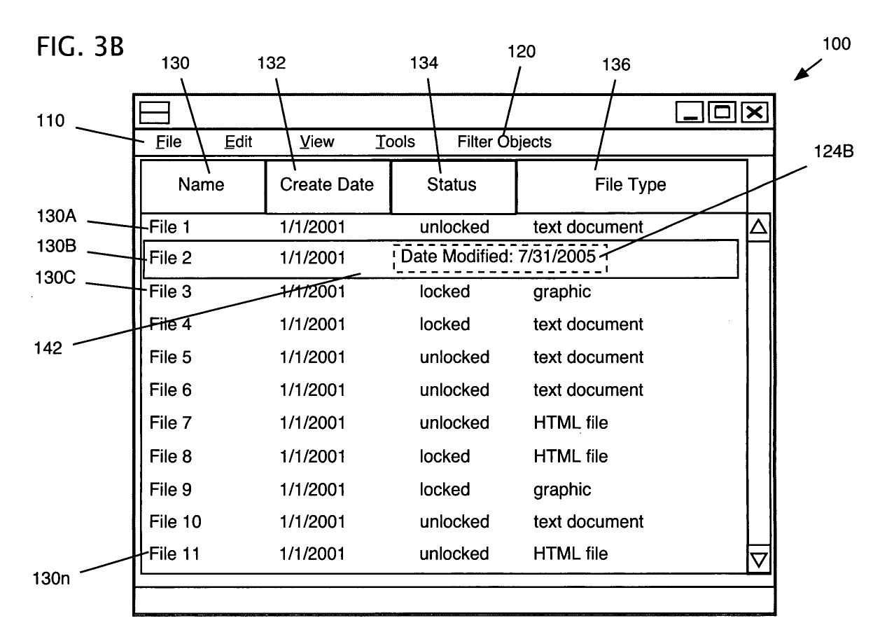

Referring now to FIGS. 3A-B, alternative embodiments of the GUI 100 of FIG. 1 are shown. In FIG. 3A, a mouse arrow 140 is shown adjacent “File 2” 130B. The “Date Modified” filter object 124 (FIG. 2) has been selected, such that data associated with “File 2” 130B but not displayed in GUI 100 is accessed and displayed in a filter display 124B, in the case that mouse arrow 140 is positioned adjacent “File 2” 130B. In a preferred embodiment, filter object 124, once selected, is “draggable” along GUI 100. That is, the data accessed and displayed in filter display 124B changes according to the location of mouse arrow 140 in GUI 100. Alternatively, the filter object may be “non-draggable,” i.e., the filter object is not accessed and the filter display is not displayed until the completion of some act independent of movement of mouse arrow 140, such as a keystroke combination or a mouse click.

In FIG. 3B, rather than a mouse arrow 140 (FIG. 3A), a highlight field 142 is used to access data associated with “File 2” 130B. Highlight field 142 may be employed, for example, using a computer keyboard, a stylus, an optical device, or any other known or later-developed method, system, or device for selecting a portion of GUI 100. As in FIG. 3A, data associated with “File 2” 130B but not displayed in GUI 100 is accessed and displayed in filter display 124B. While alternatively shown as a mouse arrow 140 (FIG. 3A) and highlight field 142 (FIG. 3B), each of which may be referred to more generally as a location indicator, any known or later-developed method, system, or device may be similarly used to select an object (e.g. “File 2” 130B) for which associated data will be accessed and, optionally, displayed in a filter display.

It should be noted that while the filter displays in FIGS. 3A-B are shown as resulting from the positioning of a location indicator adjacent “File 2” 130B, a filter display may similarly be displayed upon the positioning of a location indicator adjacent an individual record in a database file, for example, or any other graphical representation of data. That is, the invention includes accessing and, optionally, displaying data not displayed in a GUI, regardless of the source of the data (e.g., metadata associated with a file, data associated with an individual record in a database, etc.).

Alternatively, as will be recognized by one having ordinary skill in the art, one or more filter objects may be “pinned” to a data object (e.g., “File 2” 130B in FIGS. 3A-B), such that a filter display (e.g., 124B in FIGS. 3A-B) is displayed upon the positioning of a location indicator adjacent the data object without a user having to separately access a filter object (e.g., 124 in FIG. 2). Rather, in such an embodiment, the filter object is accessed upon positioning a location indicator adjacent the data object. Filter objects may be pinned or unpinned using any known or later-developed method. A data object having a pinned filter object may optionally include a graphical indication, such as an icon, indicating the presence of the pinned filter object.

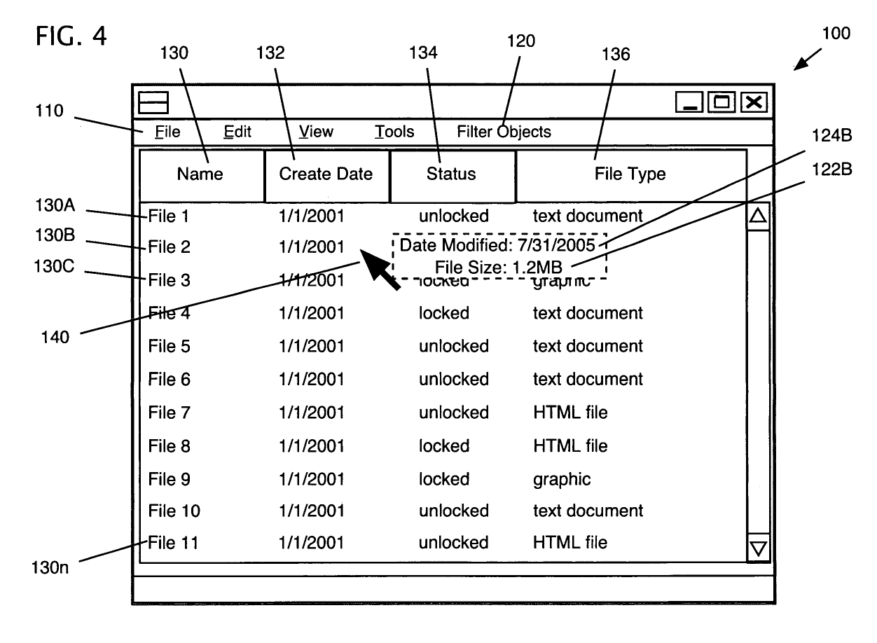

Referring now to FIG. 4, both the “File Size” filter object 122 and “Date Modified” filter object 124 of FIG. 2 have been selected, such that two filter displays 122B, 124B are displayed within GUI 100. As would be known by one having skill in the art, more than one filter object may be selected, for example, by holding a “control” key of a computer keyboard and clicking on each filter object using a computer mouse. In addition, while shown in the same general portion of GUI 100, each filter display 122B, 124B may alternatively be displayed in different or distant portions of GUI 100. Further, any filter display (e.g., 122B, 124B) may be shown adjacent to or apart from a location indicator (e.g., 140, 142).

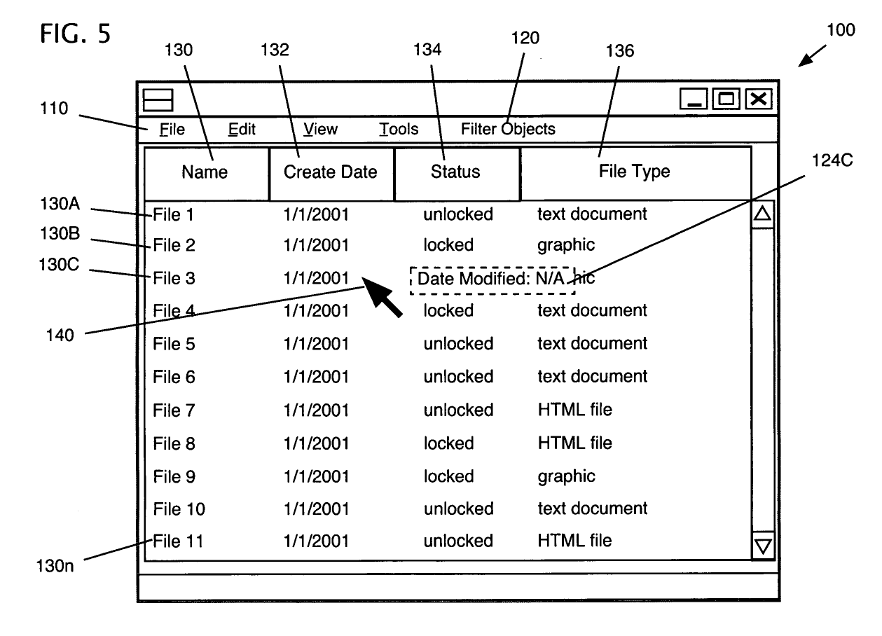

FIG. 5 shows an illustrative example of filter display 124C, wherein no data accessible using the selected filter object is associated with “File 3” 130C. As shown in FIG. 5, filter display 124C simply includes a “not applicable” (N/A) value to indicate that no data is available. Any number of other methods of informing a user that no data is available may also be employed, including, for example, providing an empty filter display or no filter display.

While described above as a visual display within GUI 100, it should be recognized that undisplayed data associated with a file or other object within GUI 100 may alternatively be displayed to a user in other ways. For example, a speech synthesizer program may display the data to a user using an audio signal. In addition, data accessed using a filter object according to the invention may be used without being displayed. For example, the accessed data may be transferred to a computer program for use by a user.

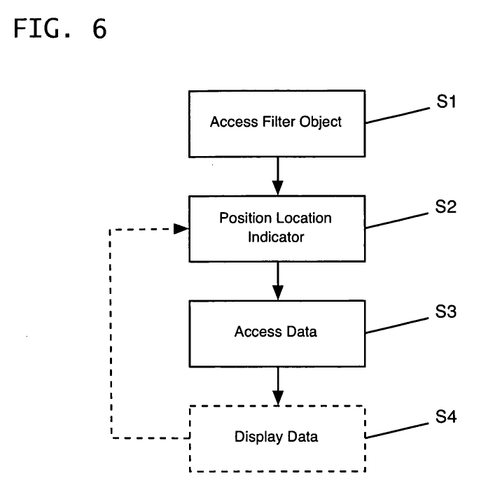

FIG. 6 shows a block diagram of an illustrative method according to the invention. At step S1, a filter object 124 (FIG. 2) is accessed, as described above. At step S2, a location indicator (e.g., 140 (FIG. 3A), 142 (FIG. 3B)) is positioned adjacent a portion of a GUI 100 (FIG. 1) or similar display. Next, at step S3, data associated with a file or object adjacent the location indicator, but not displayed, is accessed. At optional step S4, the data accessed in step S3 is displayed in a filter display 124B (FIG. 3A). As explained above, data may be “displayed” in any number of ways, including, for example, a visual display within GUI 100 or via an audio signal. As described above, in the case that the filter object accessed in step S1 is “draggable,” the location indicator may be repositioned following step S3 or optional step S4 to access data associated with other files or objects within GUI 100.

As shown in FIG. 6, a filter object 124 (FIG. 2) is first accessed and then a location indicator 140 (FIG. 3A) is positioned adjacent a portion of GUI 100 (FIG. 1). However, as noted above, it is also possible to first position a location indicator and then access a filter object 124 (FIG. 2) by, for example, executing a keyboard keystroke.

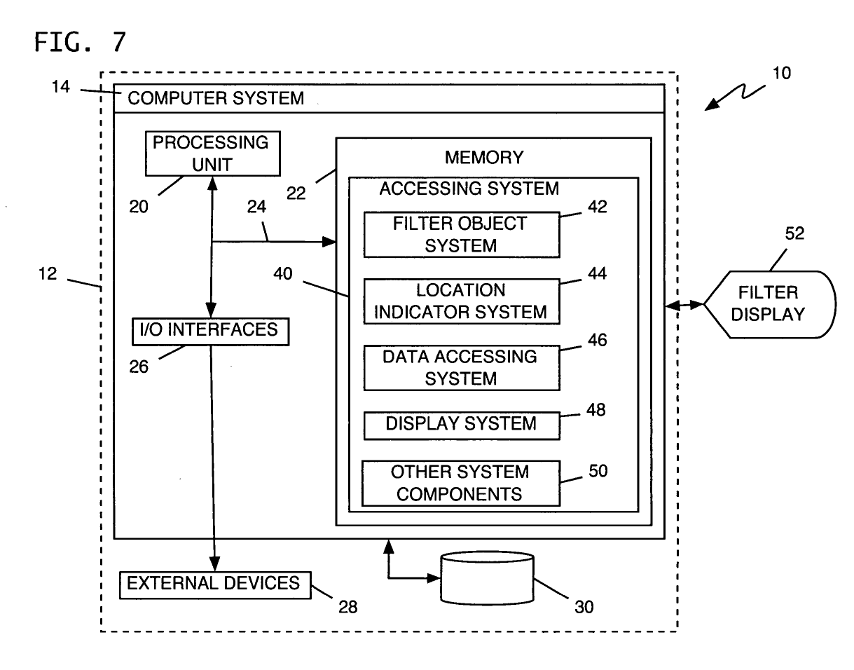

FIG. 7 shows an illustrative system 10 for accessing undisplayed data. To this extent, system 10 includes a computer infrastructure 12 that can perform the various process steps described herein for accessing undisplayed data. In particular, computer infrastructure 12 is shown including a computing device 14 that comprises an accessing system 40, which enables computing device 14 to access undisplayed data by performing the process steps of the invention.

Computing device 14 is shown including a processing unit 20, a memory 22, input/output (I/O) interfaces 26, and a bus 24. Further, computing device 14 is shown in communication with an external devices/resources 28 and a storage system 30. As is known in the art, in general, processing unit 20 executes computer program code, such as accessing system 40, that is stored in memory 22 and/or storage system 30. While executing computer program code, processing unit 20 can read and/or write data, to/from memory 22, storage system 30, and/or I/O interfaces 26. Bus 24 provides a communication link between each of the components in computing device 14. External devices/resources 28 can comprise any device that enables user (not shown) to interact with computing device 14 or any device that enables computing device 14 to communicate with one or more other computing devices.

In any event, computing device 14 can comprise any general-purpose computing article of manufacture capable of executing computer program code installed by a user (e.g., a personal computer, server, handheld device, etc.). However, it is understood that computing device 14 and accessing system 40 are only representative of various possible computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

As previously mentioned and discussed further below, accessing system 40 enables computing device 14 to access undisplayed data. To this extent, accessing system 40 is shown including a filter object system 42, a location indicator system 44, a data accessing system 46, a display system 48, and other system components 50 (e.g., speech synthesis systems, etc.). Operation of each of these systems is discussed above. Data accessed using accessing system 40 may optionally be displayed in one or more filter displays 52. As noted above, filter display 52 need not be a visual display.

It is understood that some of the various systems shown in FIG. 7 can be implemented independently, combined, and/or stored in memory for one or more separate computing devices 14 that communicate over a network. Further, it is understood that some of the systems and/or functionality may not be implemented, or additional systems and/or functionality may be included as part of system 10.

While shown and described herein as a method and system for accessing undisplayed data, it is understood that the invention further provides various alternative embodiments. For example, in one embodiment, the invention provides a computer-readable medium that includes computer program code to enable a computer infrastructure to access undisplayed data. To this extent, the computer-readable medium includes program code, such as accessing system 40 (FIG. 7), which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 7) and/or storage system 30 (FIG. 7) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to access undisplayed data as described above. In this case, the service provider can create, maintain, support, etc., a computer infrastructure, such as computer infrastructure 12 (FIG. 7), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for accessing undisplayed data. In this case, a computer infrastructure, such as computer infrastructure 12 (FIG. 7), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 7), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of accessing undisplayed data in a graphical user interface (GUI), the method comprising:
accessing at least one filter object; and
positioning a location indicator adjacent a first portion of the GUI, wherein the at least one filter object is adapted to access data not displayed in the GUI.

2. The method of claim 1, wherein the at least one filter object is further adapted to display the data.

3. The method of claim 2, wherein the data is displayed via an audio signal.

4. The method of claim 2, wherein the data is displayed in a second portion of the GUI.

5. The method of claim 4, wherein the second portion of the GUI includes the first portion of the GUI.

6. The method of claim 1, wherein the accessing step includes at least one of: executing a keystroke and selecting a portion of a computer display.

7. The method of claim 1, wherein the positioning step includes positioning the location indicator adjacent a portion of the GUI using at least one of: a computer mouse, a computer keyboard, a stylus, and an optical device.

8. The method of claim 1, wherein a first filter object and a second filter object are adapted to access different data, in the case that the accessing step includes accessing more than one filter object.

9. The method of claim 1, wherein the at least one filter object is draggable.

10. A system for accessing undisplayed data in a graphical user interface, the system comprising:
a system for accessing at least one filter object; and
a system for positioning a location indicator adjacent a first portion of the GUI,
wherein the at least one filter object is adapted to access data not displayed in the GUI.

11. The system of claim 10, further comprising a system for displaying the data.

12. The system of claim 11, wherein the system for displaying the data includes means for displaying the data via an audio signal.

13. The system of claim 11, wherein system for displaying the data includes means for displaying the data in a second portion of the GUI that includes the first portion of the GUI.

14. The system of claim 10, wherein a first filter object and a second filter object are adapted to access different data, in the case that the accessing system includes means for accessing more than one filter object.

15. The system of claim 10, wherein the at least one filter object is draggable.

16. The system of claim 10, wherein the system for positioning includes at least one of: a computer mouse, a computer keyboard, a stylus, and an optical device.

17. A program product stored on a computer-readable medium, which when executed, accesses undisplayed data in a graphical user interface (GUI), the program product comprising:
program code for accessing at least one filter object; and
program code for positioning a location indicator adjacent a portion of the GUI,
wherein the at least one filter object is adapted to access data not displayed in the GUI.

18. The program product of claim 17, wherein the at least one filter object is further adapted to display the data.

19. The program product of claim 17, wherein the at least one filter object is draggable.

20. A method for deploying an application for accessing undisplayed data in a graphical user interface (GUI), comprising:
providing a computer infrastructure being operable to:
access at least one filter object; and
position a location indicator adjacent a first portion of the GUI,
wherein the at least one filter object is adapted to access data not displayed in the GUI.
